(19) United States
(12) Patent Application Publication
(10) Pub. No.: US 2025/0073677 A1
(43) Pub. Date: Mar. 6, 2025

(54) SORBENT ARTICLE WITH SELECTIVE BARRIER LAYER

(71) Applicant: W. L. Gore & Associates, Inc., Newark, DE (US)

(72) Inventors: Edward H. Cully, Clarksville, VA (US); Christine M. Scotti, Newark, DE (US)

(21) Appl. No.: 18/562,465

(22) PCT Filed: May 17, 2022
(86) PCT No.: PCT/US2022/029583

§ 371 Date: Nov. 20, 2023

Related U.S. Application Data
(60) Provisional application No. 63/235,426, filed on Aug. 20, 2021.
(60) Provisional application No. 63/189,750, filed on May 18, 2021.

(51) Int. Cl. B01J 20/28; B01J 20/10

(52) U.S. Cl. CPC B01J 20/28035; B01J 20/103; B01J 20/2803

(57) ABSTRACT

A sorbent article is described including a sorbent region, a desorbing media region, and a selective barrier layer positioned at least between the two regions. Also described are methods of forming the sorbent article and methods of using the sorbent article for the purpose of swing adsorption, including for direct air capture (DAC) of carbon dioxide. The selective barrier layer may be impermeable to water and water vapor to protect the sorbent region. The sorbent article may be collapsible, wherein the selective barrier layer collapses into an adsorptive configuration to maximize access to the sorbent region during adsorption and expand into a desorptive configuration to maximize access to the desorbing media region during desorption.

### CROSS-REFERENCE TO RELATED APPLICATIONS

This application is a national phase application of PCT Application No. PCT/US2022/029583, internationally filed on May 17, 2022, which claims the benefit of U.S. Provisional Application No. 63/189,750, filed May 18, 2021, and U.S. Provisional Application No. 63/235,426, filed Aug. 20, 2021, all of which are incorporated herein by reference in their entireties for all purposes.

### FIELD

The present disclosure relates to a sorbent article with a selective barrier layer, methods of forming the sorbent article, and methods of using the sorbent article for the purpose of swing adsorption, including for direct air capture (DAC) of carbon dioxide.

### BACKGROUND

Increasing carbon dioxide (CO₂) levels associated with greenhouse emissions are shown to be harmful to the environment. As reported by the Climate.gov article “Climate Change: Atmospheric Carbon Dioxide,” the 2019 average carbon dioxide level in the atmosphere was 409.8 ppm, the highest level that has been noted in the past 800,000 years. The rate of increase of CO₂ in the atmosphere is also much higher than the rates in previous decades.

In order to limit the impact of climate change, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion of flue gas and subsequent CO₂ sequestration (“BECCS”) or direct air capture of CO₂ (“DAC”).

Gas separation by adsorption has many different applications in industry, for example removing a specific component from a gas stream, where the desired product can either be the component removed from the stream, the remaining depleted stream, or both. Thereby, both trace components as well as major components of the gas stream can be targeted by the adsorption process. One important gas separation application is in capturing CO₂ from gas streams, e.g., from flue gases, exhaust gases, industrial waste gases, biogas or atmospheric air. Atmospheric air is considered a dilute feed stream of CO₂.

Capturing CO₂ directly from the atmosphere, referred to as DAC, is one of several means of mitigating anthropogenic greenhouse gas emissions and has attractive economic prospects as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon these processes to make them more efficient, maximizing the amount of CO₂ removed from the atmosphere while minimizing the energy required in the process.

FIG. 1 is a schematic diagram of the process involved in a traditional DAC system 10. An input feed stream 11 is provided, containing a mixture of CO₂ molecules 16 in a non-CO₂ diluent 18. For example, the input feed stream 11 may be an air stream. During an adsorption process, the input feed stream 11 is exposed to an adsorbent 12. The CO₂ molecules 16 adsorb onto the adsorbent 12, while the non-CO₂ diluent 18 passes the adsorbent 12 and is exhausted from the system 10. The adsorbent 12 then undergoes a process of desorption in order to release the CO₂ molecules 16 from the adsorbent 12. The desorption process may involve moisture in the form of liquid water or steam or changes in the system temperature through reactions or energy delivered to the system. This desorption process is referred to as a “swing” adsorption to define the cyclic process of repeatedly adsorbing and desorbing of CO₂. If moisture swing adsorption is being used, the adsorbent 12 may be exposed to moisture in the form of water vapor or liquid water to cause the desorption of the CO₂ molecule 16. If temperature swing adsorption is being used, heat may be applied to the adsorbent 12 to cause desorption of the CO₂ molecules 16. These moisture and/or temperature swings temporarily break the bonds that retain the molecules to the adsorbent 12 so that the CO₂ molecules 16 can be released. The desorbed CO₂ molecules 16 are thus separated from the adsorbent 12 and collected as the output 14. The collected CO₂ molecules 16 can then be concentrated and subjected to further necessary processes before being used or stored. It is important that the adsorbent 12 used is able to repeatedly withstand the environments necessary for separating the CO₂ molecules 16, such as high temperatures and high moisture conditions.

There are established articles and techniques for DAC. An example is using an article including a substrate such as a monolith that supports or is coated with a sorbent material. Variations are established by changing the type of substrate and the sorbent that is used. However, these previously established articles and methods present limitations in the ability to efficiently cycle between adsorbing and desorbing states. They also have limitations with respect to the durability of the article. The articles may also degrade when exposed to high temperatures or high moisture level environments, or combinations thereof, which can result in a shorter lifetime.

### SUMMARY

A sorbent article is described including a sorbent region, a desorbing media region, and a selective barrier layer positioned at least between the two regions. Also described are methods of forming the sorbent article and methods of using the sorbent article for the purpose of swing adsorption, including for direct air capture (DAC) of carbon dioxide. The selective barrier layer may be impermeable to water and water vapor to protect the sorbent region. The sorbent article may be collapsible, wherein the selective barrier layer collapses into an adsorptive configuration to maximize access to the sorbent region during adsorption and expand into a desorptive configuration to maximize access to the desorbing media region during desorption.

According to a first example (“Example 1”), a sorbent article includes a sorbent region including a sorbent material configured to adsorb and desorb a substance, a desorbing media region positioned adjacent to the sorbent region configured to receive a desorbing media that desorbs the substance from the sorbent, and a selective barrier layer positioned at least between the sorbent region and the desorbing media region.

In one example (“Example 2”) further to Example 1, the sorbent article is flexible in at least one direction.

In one example (“Example 3”) further to Example 1 or 2, the sorbent article has a total thickness of approximately 0.5 mm to 1.0 cm.

In one example (“Example 4”) further to any one of the preceding Examples, the sorbent region is a sorbent polymer composite region comprised of at least a porous polymer and the sorbent material.

In one example (“Example 5”) further to any one of the preceding Examples, the selective barrier layer comprises a polymer.

In one example (“Example 6”) further to Example 5, the polymer is polytetrafluoroethylene (PTFE).

In one example (“Example 7”) further to any one of the preceding Examples, the sorbent article includes a second sorbent region. The sorbent region and the second sorbent region are positioned on opposing sides of the selective barrier layer.

In one example (“Example 8”) further to Example 7, the sorbent region and the second sorbent region are identical.

In one example (“Example 9”) further to any one of the preceding Examples, the selective barrier layer comprises at least one channel.

In one example (“Example 10”) further to Example 9, the at least one channel is defined by at least a first, second and third wall of the selective barrier layer.

In one example (“Example 11”) further to Example 9 or 10, the at least one channel may be compressed or expanded.

In one example (“Example 12”) further to any one of Examples 9-11, the at least one channel of the sorbent article has a cross-sectional profile that is generally rectangular.

In one example (“Example 13”) further to any one of Examples 9-12, the at least one channel of the selective barrier layer has a cross-sectional profile that is generally circular while expanded, and generally ovular when collapsed.

In one example (“Example 14”) further to any one of Examples 9-13, each of the at least one channel has a height of approximately 0.5 mm to 2 mm when expanded.

In one example (“Example 15”) further to any one of Examples 9-14, the at least one channel is defined by at least one channel wall comprising a porous and water-permeable material.

In one example (“Example 16”) further to any one of Examples 9-15, the at least one channel comprises a drainage opening located proximate an end portion of the channel through which the water is configured to be drained from within the sorbent article.

In one example (“Example 17”) further to any one of Examples 1-8, the selective barrier layer comprises at least two channels.

In one example (“Example 18”) further to Example 17, the at least two channels are interconnected.

In one example (“Example 19”) further to Example 17 or 18, the at least two channels are positioned generally parallel to one another.

In one example (“Example 20”) further to any one of Examples 1-12, the selective barrier layer is non-collapsible such that the selective barrier layer retains its shape between an adsorption configuration and a desorption configuration.

In one example (“Example 21”) further to any one of the preceding Examples, the selective barrier layer is selectively impermeable to water and water vapor.

In one example (“Example 22”) further to any one of Examples 1-20, the selective barrier layer is selectively permeable to water vapor and selectively impermeable to water.

According to another example (“Example 23”), a module includes at least one sorbent article, each sorbent article comprising at least one sorbent region, a desorbing media region, and a selective barrier region positioned at least between the desorbing media region and the sorbent region, and at least one adsorption pathway in communication with the sorbent region.

In one example (“Example 24”) further to claim 23, the selective barrier layer comprises at least one desorption channel.

In one example (“Example 25”) further to claim 23, the module comprises a plurality of sorbent articles and at least one adsorption pathway is formed between each of the plurality of sorbent articles.

In one example (“Example 26”) further to claim 25, each of the plurality of sorbent articles comprise two sorbent regions with the desorbing media region and selective barrier layer sandwiched between the two sorbent regions.

In one example (“Example 27”) further to claim 25 or 26, each of the plurality of sorbent articles is flexible in at least one direction such that the desorbing media region is expandible and collapsible.

According to another example (“Example 28”), a method of forming a sorbent article includes providing a sorbent region composed of at least a sorbent material, providing a desorbing media region, providing a selective barrier layer at least between the sorbent region and the desorbing media region, and attaching the sorbent region to the selective barrier layer.

In one example (“Example 29”) further to Example 28, the providing the selective barrier layer comprises: providing the selective barrier layer to surround the desorbing media region such that the selective barrier layer forms at least one desorption channel.

In one example (“Example 30”) further to Example 28 or 29, providing the selective barrier layer further includes providing the selective barrier layer to surround the sorbent region.

In one example (“Example 31”) further to any one of Examples 28-30, the method further includes adding an adhesive material which facilitates thermal conductivity.

In one example (“Example 32”) further to any one of Examples 28-31, the sorbent material is an ion exchange resin, zeolite, activated carbon, alumina, metal-organic frameworks, or polyethyleneimine (PEI).

In one example (“Example 33”) further to any one of Examples 28-32, the sorbent region further comprises a porous polymer, the porous polymer being expanded polytetrafluoroethylene or expanded polyethylene.

In one example (“Example 34”) further to Example 29, the selective barrier layer comprises a flexible polymer bordering each of the at least one desorption channels.

In one example (“Example 35”) further to Example 34, the flexible polymer is polytetrafluoroethylene or polyethylene.

In one example (“Example 36”) further to any one of Examples 28-35, the attaching the sorbent region to the selective barrier layer includes: laminating the sorbent region to a first side of the selective barrier layer.

In one example (“Example 37”) further to Example 36, the method further includes providing a second sorbent region comprised of at least a sorbent material and a porous polymer, and attaching the second sorbent region to a second side of the selective barrier layer.

In one example (“Example 38”) further to Example 37, attaching the second sorbent region to the second side of the selective barrier layer includes laminating the second sorbent region to the second side of the selective barrier layer.

According to a fourth example (“Example 39”), a method of using a module having a plurality of sorbent articles includes (a) providing the module composed of the plurality of sorbent articles positioned adjacent one another, such that spaces between adjacent sorbent articles form adsorption pathways and each of the sorbent articles comprises at least one desorption channel surrounded by a selective barrier layer, (b) adsorbing carbon dioxide from a feed stream by directing the feed stream through the adsorption pathways of the module, the adsorption pathways expanding and the desorption channels collapsing, and (c) desorbing the carbon dioxide by directing a desorbing media through the desorption channels of the module, the desorption channels expanding and the adsorption pathways collapsing.

In one example (“Example 40”) further to Example 39, the desorbing media is steam.

In one example (“Example 41”) further to Example 39 or 40, the adsorbing step (b) comprises: directing the feed stream along a generally horizontal axis of the module.

In one example (“Example 42”) further to any one of Examples 39-41, the desorbing step (c) comprises: directing the desorbing media along a generally vertical axis of the module.

In one example (“Example 43”) further to any one of Examples 39-42, the method further includes (d) collecting the carbon dioxide that is desorbed in step (c).

In one example (“Example 44”) further to any one of Examples 39-43, the method further includes repeating the adsorbing step (b) after the desorbing step (c).

According to a fifth example (“Example 45”), a module includes a plurality of sorbent articles, each sorbent article including at least one sorbent region, a desorbing media region, and a selective barrier layer, the selective barrier layer being flexible in at least one direction, and the selective barrier layer having a decreased thickness when in an adsorptive configuration and an increased thickness when in a desorptive configuration.

In one example (“Example 46”) further to Example 45, the selective barrier layer comprises a plurality of channels.

In one example (“Example 47”) further to Example 45 or 46, the sorbent article has a decreased total thickness in the adsorptive configuration and an increased total thickness in the desorptive configuration.

In one example (“Example 48”) further to Example 47, the desorbing media region has a decreased width in the adsorptive configuration and an increased width in the desorption configuration, and the sorbent region has a thickness that is substantially the same in the adsorptive configuration and in the desorptive configuration.

In one example (“Example 49”) further to Example 45 or 46, the sorbent article comprises a total thickness that is substantially the same in the adsorptive configuration and in the desorptive configuration.

In one example (“Example 50”) further to Example 49, the sorbent region of the sorbent article has an increased thickness in the adsorptive configuration and a decreased thickness in the desorptive configuration, and the desorbing media region has a decreased thickness in the adsorptive configuration and an increased thickness in the desorptive configuration, such that the total thickness of the sorbent article is substantially the same in the adsorptive configuration and in the desorptive configuration.

According to a sixth example (“Example 51”), a method of using a module having a fixed volume comprising at least one sorbent article, the sorbent article having a sorbent region, a desorbing media region, and a selective barrier layer positioned at least between the sorbent region and the desorbing media region, includes (a) adsorbing carbon dioxide from a feed stream by directing the feed stream through the sorbent region of the sorbent article, and (b) desorbing the carbon dioxide from the sorbent region by directing a desorbing media through the desorbing media region of the sorbent article. The method further includes wherein the sorbent region occupies more of the fixed volume of the module during the adsorbing step (a) than the desorbing step (b) and wherein the desorbing media region occupies more of the fixed volume of the module during the desorbing step (b) than the adsorbing step (a).

In one example (“Example 52”) further to Example 51, the method further includes (c) collecting the carbon dioxide after the desorbing step (b).

In one example (“Example 53”) further to Example 52, the method further includes repeating the adsorbing step (a) after the collecting step (c).

### BRIEF DESCRIPTION OF THE DRAWINGS

FIG. 1 is a schematic diagram of the process involved in a prior-art DAC system.

FIG. 2 is an elevational view of a sorbent article of the present disclosure.

FIG. 3A is an elevational view of a sorbent article of the present disclosure in an adsorptive configuration.

FIG. 3B is an elevational view of the sorbent article of FIG. 3A in a desorptive configuration.

FIG. 3C is an elevational view of the sorbent article of FIG. 3B illustrated with an end-sealing region of the present disclosure.

FIG. 3D is a schematic illustration of a sorbent article with continuous coating of the present disclosure.

FIG. 4A is an elevational view of an aspect of a sorbent article of the present disclosure in an adsorptive configuration.

FIG. 4B is an elevational view of the aspect of FIG. 4A in a desorptive configuration.

FIG. 5 is a flowchart illustrating a method of forming the sorbent article of FIG. 3A and FIG. 3B.

FIG. 6 is an elevational view of an aspect of a module of the present disclosure.

FIG. 7A is a top view of a module of the present disclosure in an adsorptive configuration.

FIG. 7B is a top view of the module of FIG. 7A in a desorptive configuration.

FIG. 8 is a flow chart illustrating a method of using the module of FIG. 7A and FIG. 7B.

FIG. 9A is a cross-sectional view of a sorbent article in accordance with Example A of the present disclosure in one configuration.

FIG. 9B is a cross-sectional view of a sorbent article in accordance with Example A of the present disclosure in another configuration.

FIG. 9C is an image of a selective barrier layer having a plurality of interconnected channels in accordance with Example A of the present disclosure in another configuration.

FIG. 10A is a cross-sectional view of a sorbent article in accordance with Example B of the present disclosure without a lumen for collecting water droplets.

FIG. 10B is a cross-sectional view of a sorbent article in accordance with Example B of the present disclosure with the lumen for collecting water droplets in accordance with examples disclosed herein.

### DETAILED DESCRIPTION

The present disclosure relates to a sorbent article, methods of forming a sorbent article, and methods of using a sorbent article to adsorb and separate one or more desired substances from an input. While the sorbent article is described below for use in capture of CO₂ from an air feed stream, it may be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the desired substance.

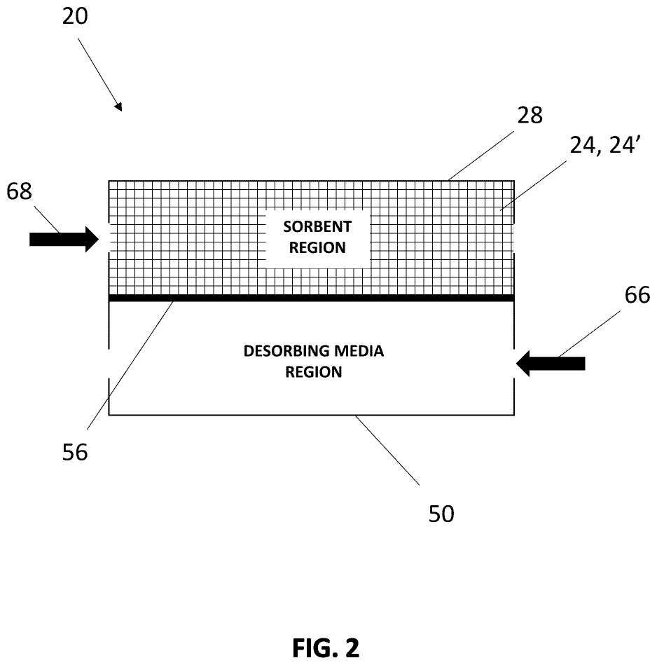

FIG. 2 is an elevational view of a sorbent article 20 of the present disclosure. The sorbent article 20 comprises a sorbent region 28, a selective barrier layer 56, and a desorbing media region 50. The illustrative sorbent article 20 is configured to capture CO₂ from an air feed stream 68, but as noted above, the sorbent article 20 may be used in other adsorbent methods and applications.

The sorbent region 28 includes a sorbent material 24, 24′. The sorbent region 28 is positioned such that the feed stream 68 may pass adjacent to or within the sorbent region 28 to allow for adsorption of CO₂ within the feed stream 68 onto the sorbent material 24, 24′ within the sorbent region 28.

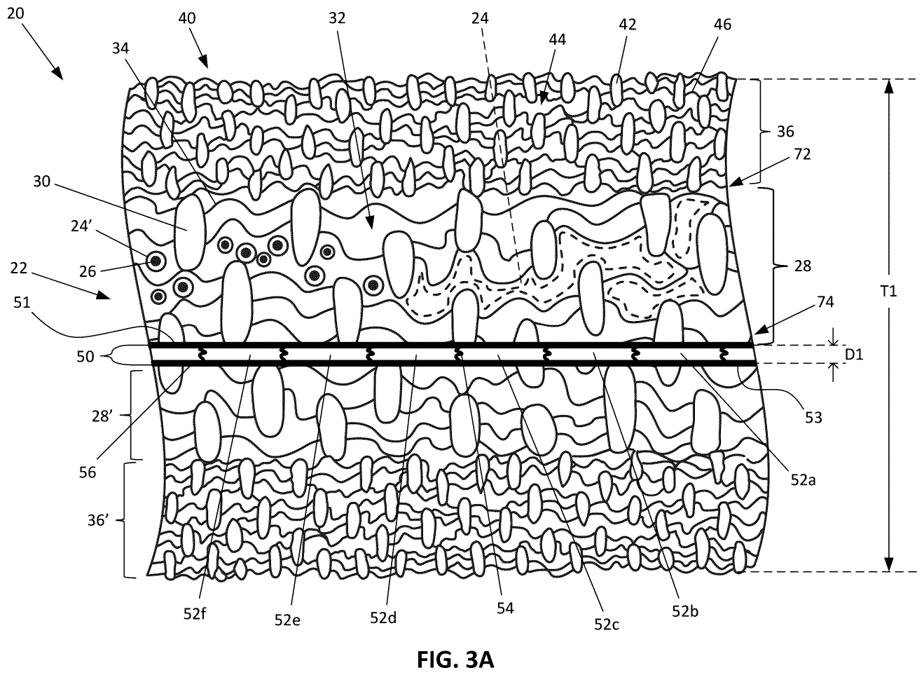

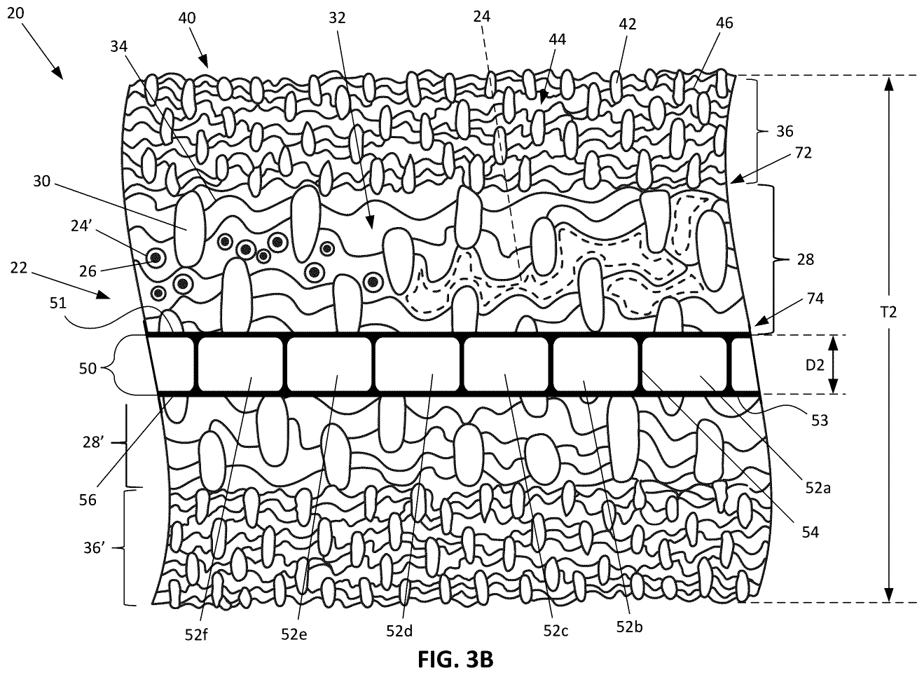

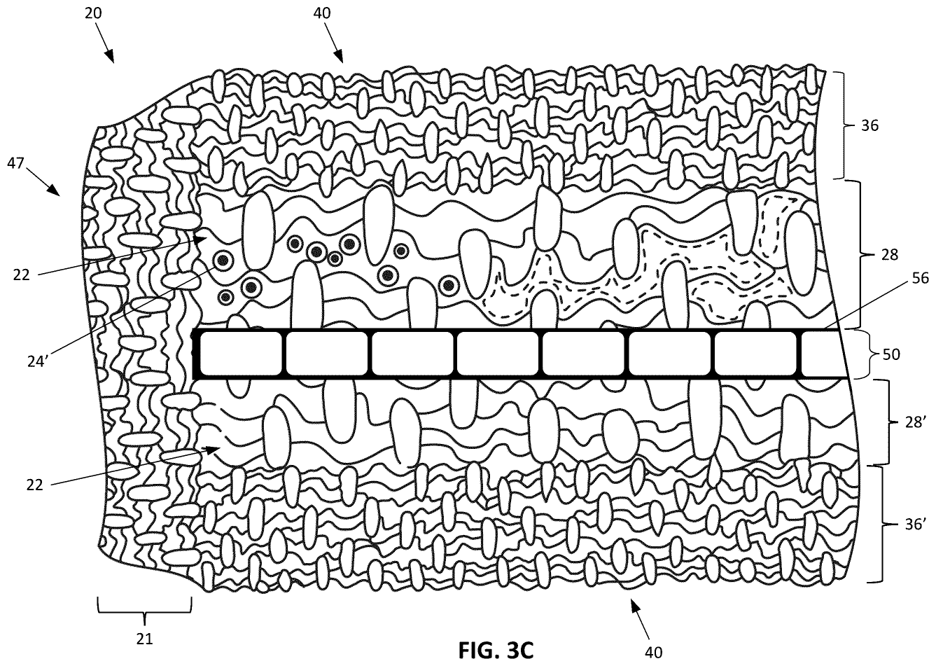

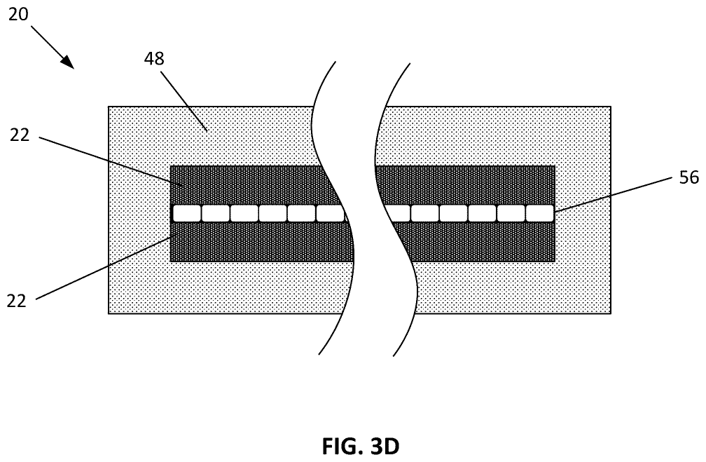

The desorbing media region 50 receives a desorbing media 66. The desorbing media 66 may be a substance that is used to desorb the adsorbed substance of the feed stream 68 from the sorbent material 24, 24′. The desorbing media 66 will be described further with reference to FIGS. 3A and 3B.

The sorbent article 20 includes the selective barrier layer 56 positioned at least between the sorbent region 28 and the desorbing media region 50, forming a selectively permeable barrier at least between the sorbent region 28 and the desorbing media region 50. The selective barrier layer 56 is selectively permeable to at least a desorbing element of the desorbing media 66 that is capable of desorbing the adsorbed substance from the sorbent material 24, 24′, while being selectively impermeable to other elements of the desorbing media 66, especially elements that may damage the sorbent material 24, 24′. Thus, the selective barrier layer 56 may function as a gate, controlling which element(s) enter the sorbent region 28 and which element(s) do not enter the sorbent region 28. In various embodiments, the desorbing media 66 in the desorbing media region 50 may be steam. If temperature swing adsorption is being used, the selective barrier layer 56 may be selectively permeable to heat from the steam, such that heat moves from the desorbing media region 50 into the sorbent region 28 to desorb CO₂ from the sorbent material 24, 24′. However, the selective barrier layer 56 may be selectively impermeable to water vapor. In some embodiments, the selective barrier layer 56 may be selectively permeable to water vapor but selectively impermeable to liquid water.

The selective barrier layer 56 may additionally vary in shape. In some embodiments, the selective barrier layer 56 surrounds one or both of the sorbent region 28 and the desorbing media region 50 to define a channel for the sorbent region 28 and/or the desorbing media region 50. In these embodiments, the selective barrier layer 56 may include multiple walls, as will be described further herein with reference to the examples of FIGS. 3A and 3B. Additionally, the selective barrier layer 56 may be flexible such that it can collapse and expand, thereby allowing for the sorbent region 28 and/or desorbing media region 50 to also collapse and expand. In other embodiments, the selective barrier layer 56 may be a single-wall structure that spans a length of the sorbent article 20 between the sorbent region 28 and the desorbing media region 50. In summary, the sorbent article 20 comprises the sorbent region 28 wherein adsorption and desorption are capable of occurring, as well as the desorbing media region 50 containing the desorbing media 66, and the selective barrier layer 56 configured to separate the sorbent region 28 and desorbing media region 50.

A first example of the sorbent article 20 of the present disclosure is shown in FIGS. 3A and 3B. In these embodiments, the sorbent article 20 may be flexible in at least one direction. In particular, the selective barrier layer 56 of the sorbent article 20 may be flexible in at least one direction. This flexibility allows for the sorbent article 20 to collapse into an adsorptive configuration (FIG. 3A) and expand into a desorptive configuration (FIG. 3B). It is important to note that the figures are drawn to assist in the depiction of the sorbent article and components thereof, therefore the proportions may be exaggerated in order to bring clarity to the components.

FIG. 3A shows the sorbent article 20 in the collapsed, adsorptive configuration. In the illustrated embodiment, the sorbent article 20 comprises the sorbent region 28. In the illustrated embodiment of FIG. 3A, the sorbent region 28 is a sorbent polymer composite region that includes a first porous polymer 22 and retained solids illustratively comprising the sorbent material 24, 24′. The sorbent region 28 may also include an optional carrier 26. Each element of the sorbent region 28 is described further below. Although the figures and the following description are directed to the sorbent article 20 having the sorbent region 28, it is also within the scope of the present disclosure for the sorbent material 24 and/or 24′ to be present in other forms.

The first porous polymer 22 of the sorbent region 28 may be one of expanded polytetrafluoroethylene (ePTFE), polytetrafluoroethylene (PTFE), expanded polyethylene (ePE), or another suitable porous polymer. In various embodiments, the first porous polymer 22 of the sorbent region 28 is a flexible porous polymer. It will be appreciated that non-woven materials such as nanospun, meltblown, spunbond, and porous cast films could be among the various other suitable porous polymers. The first porous polymer 22 may be expanded by stretching the polymer at a controlled temperature and a controlled stretch rate, causing the polymer to fibrillate. Following expansion, the first porous polymer 22 may comprise a microstructure of a plurality of nodes 30 and a plurality of fibrils 34 that connect adjacent nodes 30. In these instances, the first porous polymer 22 includes pores 32 bordered by the fibrils 34 and the nodes 30. An exemplary node and fibril microstructure is described in U.S. Pat. No. 3,953,566 to Gore. The pores 32 of the first porous polymer 22 may be considered micropores. Such micropores may have a single pore size or a distribution of pore sizes. The average pores size may range from 0.1 microns to 50 microns in certain embodiments.

The sorbent material 24, 24′ of the sorbent region 28 is a substrate having a surface configured to hold the desired substance from the input on the surface via adsorption. The sorbent material 24, 24′ varies based on which substances are targeted for adsorption. In various embodiments, the sorbent material 24, 24′ is a carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silicoaluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imidazolate framework and metal organic framework (MOF) adsorbent compounds, and combinations thereof.

The sorbent material 24, 24′ may be present in the first porous polymer 22 as a coating, a filling, entrained particles, and/or in another suitable form, as described further below. In the illustrated embodiment of FIG. 3A, the first porous polymer 22 is coated with the sorbent material 24, such that the sorbent material 24 forms a substantially continuous coating on the nodes 30 and/or fibrils 34 of the first porous polymer 22. It is also within the scope of the present disclosure for the first porous polymer 22 to be filled with the sorbent material 24, such that the sorbent material 24 is incorporated into the nodes 30 and/or fibrils 34 of the first porous polymer 22. In the illustrated embodiment of FIG. 3A, the particles of the sorbent material 24′ on the carrier 26 are entrained in the first porous polymer 22, such that the sorbent material 24′ occupies the pores 32 between the nodes 30 and fibrils 34 of the first porous polymer 22.

The optional carrier 26 of the sorbent region 28 is a material that is configured to increase the surface area of the region it occupies which may allow for an increased surface area that is available for adsorption of the desired substance. The carrier 26 may include a mesoporous silica, polystyrene beads, porous polymeric bed or sphere, oxide supports, another suitable carrier material. The carrier 26 may further include a porous film comprising porous inorganic materials within it such as calcium sulfate, alumina, activated charcoal and fumed silica. As noted above, the carrier 26 may be present in the pores 32 of the sorbent region 28 as high surface area particles that are coated or functionalized with the sorbent material 24′. The combination of the carrier 26 coated with the sorbent material 24′ increases the surface area available for adsorption. In these embodiments, the nodes 30 and fibrils 34 may or may not be coated with sorbent material 24. When the nodes 30 and fibrils 34 are not coated, the original hydrophobicity of the first porous polymer 22 may be retained.

The sorbent region 28 of the sorbent article 20 includes a first side 72 (e.g., an upper side in FIG. 3A) and a second side 74 (e.g., a lower side in FIG. 3A). In some embodiments, the sorbent article 20 further includes an outer porous polymeric region 36 comprising a second porous polymer 40, where the outer porous polymeric region 36 is positioned adjacent to the first side 72 of the sorbent region 28. The second porous polymer 40 of the outer porous polymeric region 36 may comprise a plurality of nodes 42, a plurality of fibrils 46 that connect adjacent nodes 42, and a plurality of pores 44 that are each formed between the respective nodes 42 and fibrils 46. The pores 44 of the second porous polymer 40 may be considered micropores, as described further above.

The sorbent region 28 and the outer porous polymeric region 36 of the sorbent article 20 may be formed using different processes. In certain embodiments, the sorbent region 28 and the outer porous polymeric region 36 may be formed as discrete layers and then coupled together. In this case, the first porous polymer 22 of the sorbent region 28 and the second porous polymer 40 of the outer porous polymeric region 36 may be distinct structures. In other embodiments, the sorbent region 28 and the outer porous polymeric region 36 may be formed together and then subjected to different coating processes or surface treatments, as described further below, to differentiate certain regions. In this case, the first porous polymer 22 of the sorbent region 28 and the second porous polymer 40 of the outer porous polymeric region 36 may be continuous or integrated structures.

The sorbent region 28 and the outer porous polymeric region 36 of the sorbent article 20 may have differing degrees of hydrophobicity. The hydrophobicity may be altered through various methods, such as through applying coatings or surface treatments, which may include, but are not limited to, plasma etching and applying micro-topographical features. The sorbent region 28 has a first hydrophobicity and the outer porous polymeric region 36 may have a second hydrophobicity. The first hydrophobicity is less than the second hydrophobicity. The greater hydrophobicity of the outer porous polymeric region 36 may reduce the permeation of contaminants through the sorbent region 28 thus forming a barrier between any contaminants in the feed stream 68 (FIG. 2), or in the environment through which the feed stream 68 is being directed, and the components of the sorbent region 28. This reduces degradation of the sorbent material 24, 24′ within the sorbent region 28 that water or other contaminants could cause, increasing the lifetime and durability of the sorbent article 20. The greater hydrophobicity of the outer porous polymeric region 36 relative to the sorbent region 28 may result from the lack of sorbent material 24,24′ within the outer porous polymeric region 36.

In some embodiments, the sorbent region 28 is sealed with a coating (not shown). In certain instances, the coating is configured to be a carbon dioxide adsorbing material similar to the above-described sorbent materials 24, 24′.

The polymer of the outer porous polymeric region 36 may be at least one of polytetrafluoroethylene (PTFE), expanded polytetrafluoroethylene (ePTFE), expanded polyethylene (ePE), and other suitable porous polymers. In some examples, the first porous polymer 22 of the sorbent region 28 may be identical to the second porous polymer 40 of the outer porous polymeric region 36. In various embodiments, the thickness of the outer porous polymeric region 36 is less than that of the sorbent region 28.

The pore characteristics of the first and second porous polymers 22 and 40 of the sorbent region 28 and the outer porous polymeric region 36 are variable. In certain embodiments, the outer porous polymeric region 36 may have fewer and/or smaller pores 44 than the sorbent region 28 to selectively limit permeation of undesired contaminants (e.g., water) into the sorbent region 28 while permitting permeation of desired molecules (e.g., CO₂) into the sorbent region 28. By contrast, the sorbent region 28 may have more and/or larger pores 32 than the outer porous polymeric region 36 to encourage movement of CO₂ through the sorbent region 28 for adsorption and desorption.

Further, the pore characteristics can be varied among different embodiments. This variation of the pore characteristics can be dependent on the thickness T1, T2 of the sorbent article 20, as well as of the individual thicknesses of the sorbent region 28 and outer porous polymeric regions 36.

In the illustrated embodiment of FIG. 3A, the selective barrier layer 56 surrounds the desorbing media region 50. The illustrative selective barrier layer 56 includes a first wall 51 (e.g., an upper wall in FIG. 3A) positioned adjacent to the sorbent region 28, a second wall 53 (e.g., a lower wall in FIG. 3A), and one or more flexible, interior walls 54. Together, the first wall 51, the second wall 53, and the interior flexible walls 54 of the selective barrier layer 56 cooperate to define channels 52a-f. The desorbing media region 50 is located within the channels 52a-f of the selective barrier layer 56, and as such, the channels 52a-f may also be referred to herein as “desorption channels”. The surrounding walls 51, 53, 54 of the selective barrier layer 56 separate the desorbing media region 50 from the adjacent sorbent region 28. The outer walls 51, 53 of the selective barrier layer 56 may be selectively permeable, as described above. In certain instances, the outer walls 51, 53 of the selective barrier layer 56 are formed of a polymer such as polytetrafluoroethylene, polyethylene, or another suitable material. The interior walls 54 of the selective barrier layer 56 may be formed of the same polymer or a different material. Thus, the selective barrier layer 56 provides discrete desorption channels 52a-f for desorbing media 66 (FIG. 2) to be applied with selective permeability and access to the sorbent region 28, as described above. In the temperature swing example, the sorbent material 24, 24′ of the sorbent region 28 may remain protected from the fluid of the desorbing media 66 passing through the desorbing media region 50, which may damage the sorbent material 24, 24′ within the sorbent region 28 if able to contact the sorbent material 24, 24′. It will be understood that the channels 52a-f may be referred to herein as “adsorption channels” in embodiments where the sorbent region 28 is present within the selective barrier layer 56.

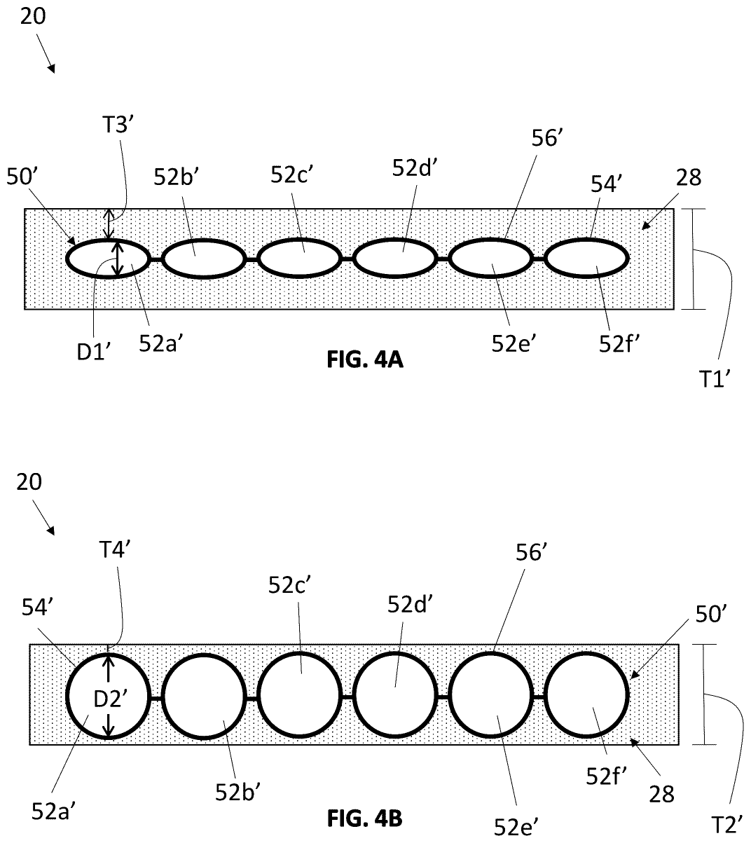

In the adsorptive configuration of FIG. 3A, the desorption channels 52a-f of the selective barrier layer 56 are collapsed to a width D1 to minimize the volume occupied by the desorbing media region 50 when not in use. In the illustrated embodiment of FIG. 3A, the interior flexible walls 54 are bent, buckled, tilted, or otherwise shortened to achieve this collapsed configuration. As a result, the overall thickness T1 of the sorbent article 20 may be smaller than in the subsequent desorptive configuration of FIG. 3B. In various embodiments, as will be described with reference to FIGS. 4A and 4B, the overall thickness T1 of the sorbent article 20 may be constant, while a thickness of the at least one sorbent region 28 may change.

The cross-sectional shape of the desorption channels 52a-f may vary. In the illustrated embodiment of FIGS. 3A and 3B, the cross-sectional profile of each of the desorption channels 52a-f is generally rectangular. In other embodiments, the cross-sectional profile of each of the desorption channels 52a-f may be of a different shape such as circular, ovular, or square.

The arrangement and other features of the desorption channels 52a-f may also vary. For example, the desorption channels 52a-f may be interconnected or independent of one another. In the illustrated embodiment of FIGS. 3A and 3B, the desorption channels 52a-f are arranged generally parallel to one another. In other embodiments, the desorption channels 52a-f may be arranged transverse to one another in an intersecting and/or overlapping manner. Also, while the desorption channels 52a-f are illustrated to be positioned within a relative center of the sorbent article 20, the selective barrier layer 56 may be positioned in various desired area of the sorbent article 20, such that it forms the various desorption channels 52a-f throughout the sorbent article 20. Further, the selective barrier layer 56 may be composed of microchannels positioned throughout the sorbent article 20.

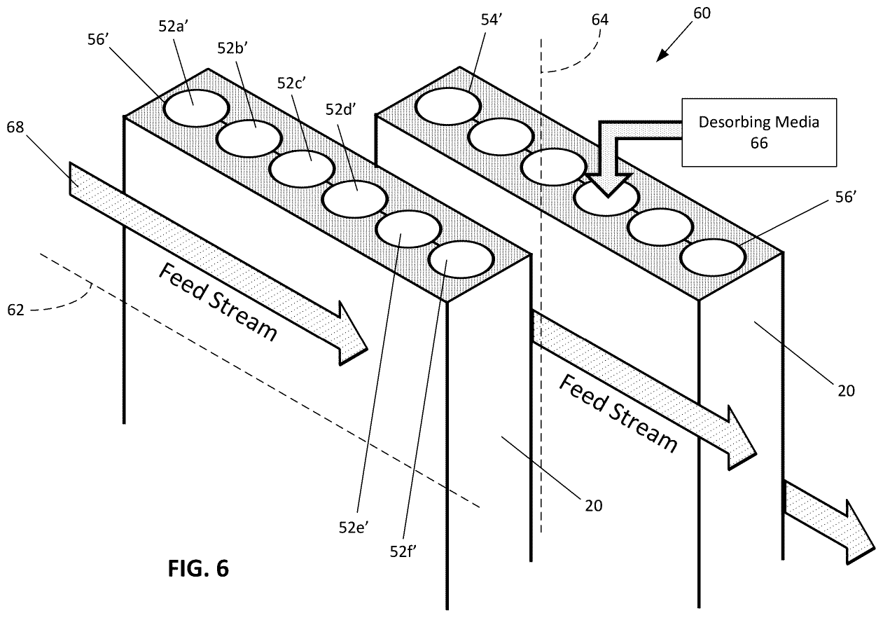

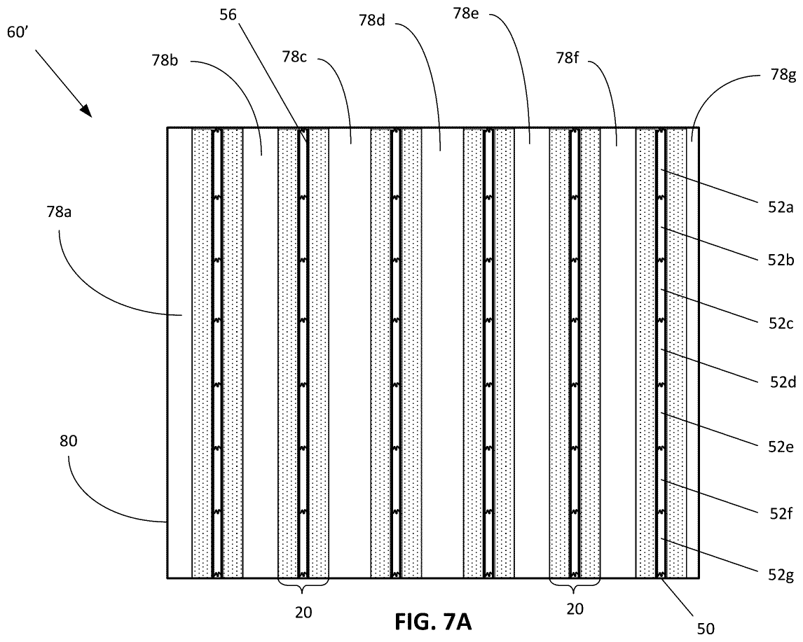

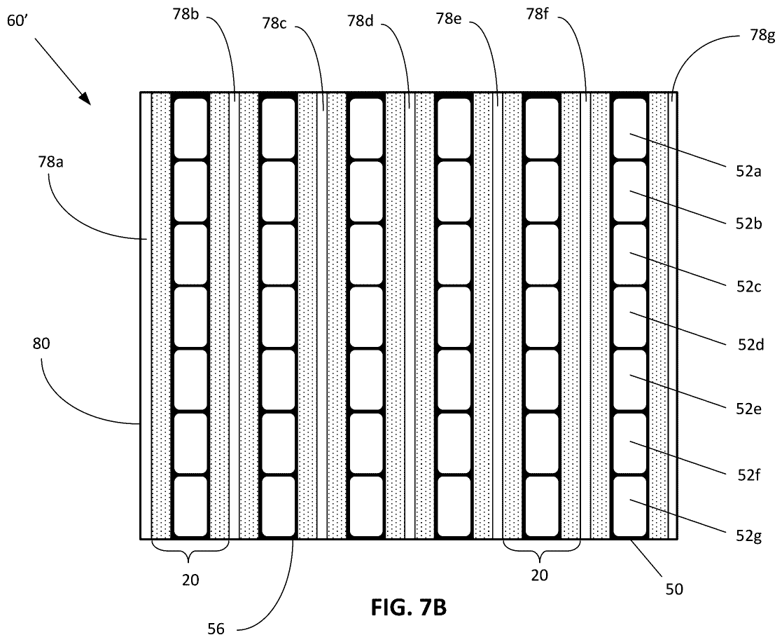

In embodiments, the sorbent article 20 may comprise a second sorbent region 28′. The first sorbent region 28 may be positioned adjacent to the first wall 51 of the selective barrier layer 56, and the second sorbent region 28′ may be positioned adjacent to the second wall 53 of selective barrier layer 56. In this way, the sorbent region 28 and the second sorbent region 28′ are positioned on opposing sides of the selective barrier layer 56, and thus the desorbing media region 50 is sandwiched between the two sorbent regions 28, 28′. This sandwiched arrangement allows the sorbent article 20 to be positioned adjacent other sorbent articles 20 and still retain a desired adsorptive function and also maximizes the usage of the desorbing media region 50, which maximizes the volume of space used by the module, as will be described further herein with reference to FIGS. 6, 7A, and 7B. Additionally, in some embodiments as illustrated in FIG. 3A, there may be an additional layer of the outer porous polymeric region 36′ that is positioned adjacent the second sorbent region 28′.

FIG. 3B shows the sorbent article 20 of FIG. 3A in the expanded, desorptive configuration. In this desorptive configuration, the desorption channels 52a-f of the selective barrier layer 56 are expanded to a width, D2 such that a desorbing media 66 (FIG. 2) can pass through the desorbing media region 50 located within the desorption channels 52a-f. More specifically, the interior flexible walls 54 have moved from the bent, buckled, tilted, or shortened configuration in the adsorptive configuration of FIG. 3A to a straight or elongated configuration in the desorptive configuration of FIG. 3B. In certain instances, the desorbing media 66 is steam. The heat from the steam is able to permeate each of the desorption channels 52a-f into the sorbent regions 28, 28′, such that the heat desorbs the carbon dioxide from the sorbent materials 24, 24′. While the desorbing media 66 is often described with reference to steam, the desorbing media 66 may include any media having a desorbing element (e.g., heat) that is capable of desorbing the adsorbed substance from the sorbent material 24, 24′. In some embodiments, the use of materials and components that assist in thermal conductivity may be employed. As an example, the upper and lower surfaces of the selective barrier layer 56 may be metalized or, the adhesive used to attach selective barrier layer 56 to sorbent region 28 may include metallic powders or other thermally conductive materials. In the desorptive configuration, the sorbent article 20 may have an overall thickness T2 that may range from approximately 0.5 mm to 5.0 mm. The overall thickness T2 in the desorptive configuration of FIG. 3B may be greater than or equal to the overall thickness T1 in the adsorptive configuration of FIG. 3A.

FIG. 3C is an additional elevational view of the sorbent article of FIG. 3B with an additional end-sealing region 21. In certain embodiments, the sorbent article 20 includes this end-sealing region 21 to protect the components of the sorbent article 20. For example, if the sorbent article 20 is cut or split in any manner, such as for production or manufacturing purposes, it may leave the sorbent regions 28, 28′ and thus the sorbent material 24, 24′ within the sorbent regions 28, 28′ exposed to external environment elements such as water or steam, which may be harmful to properties of the sorbent article 20. Thus, embodiments with an end-sealing region 21 may be desirable. As illustrated in FIG. 3C, the end-sealing region 21 is positioned such that it connects at least the second polymer 40 of the outer porous polymeric region 36 and the first polymer 22 of the sorbent region 28. In embodiments, it may connect the polymers 40 of the outer porous polymer regions 36, 36′. In further embodiments, the end sealing region 21 connects at least two of the second polymer 40 of the outer porous polymer region 36, the second polymer 40 of the outer porous polymer region 36′, the first polymer 22 of the sorbent region 28, and the first polymer 22 of the sorbent region 28′. The end sealing region 21 covers the exposed first polymer 22 of the sorbent regions 28, 28′ on at least one side.

In the illustrated embodiment of FIG. 3C, the end-sealing region 21 is formed by applying an additional layer of a sealing material 47 onto the sorbent article 20. The sealing material 47 may be the same as or different from the materials of the outer porous polymer regions 36, 36′. For example, the sealing material 47 may be ePTFE (as shown in FIG. 3C), ePE, silicone elastomer, or any other suitable non-porous and/or hydrophobic material that protects the sorbent regions 28, 28′. In other embodiments, the end-sealing region 21 may be formed by extending the outer porous polymer regions 36, 36′ and coupling (e.g., pinching, adhering) the regions 36, 36′ together. The addition of this edge sealing step will benefit the composite by protecting the sorbent(s) retained in the composite and also by toughening the leading edge of the composite (which is the area most likely to incur damage from airborne debris and high-velocity strikes).

FIG. 3D shows an example of the sorbent article 20 in which the second porous polymer 40 of the outer porous polymeric region 36, 36′ and the sealing material 47 of the end-sealing region 21, as shown in FIG. 3C, are formed from a unitary, monolithic, or continuous material (e.g., a tube or a sheet with end portions connected to form a closed loop) to form a seamless protective layer 48 covering the first porous polymer 22 and the selective barrier layer 56.

FIG. 4A is another embodiment of a desorbing media region 50′ surrounded by a selective barrier layer 56′ of the present disclosure shown in the collapsed, adsorptive configuration. In the collapsed, adsorptive configuration, the sorbent article 20 comprises an overall thickness T1′. The sorbent article 20 additionally comprises at least one sorbent region 28 positioned adjacent the selective barrier layer 56′. The sorbent region 28 may have a first thickness T3′ measured from adjacent the selective barrier layer 56′ to the upper boundary of the sorbent article 20. The selective barrier layer 56′ comprises at least one desorption channel 52a′ wherein the desorbing media region 50′ is located. In the illustrative embodiment of FIG. 4A, the selective barrier layer 56′ comprises six desorption channels 52a-f′. Each of the desorption channels 52a-f′ are surrounded by a continuous round wall 54′ to create the barrier between the desorption channels 52a-f′ and the at least one sorbent region 28 positioned adjacent the desorbing media region 50′. In this embodiment, the sorbent region 28 is positioned surrounding the entirety of the selective barrier layer 56′ and thus the desorbing media region 50′. In this adsorptive configuration, the walls 54′ of the desorption channels 52a-f′ are collapsed to a generally ovular cross-sectional profile having a width D1′ (i.e., diameter).

FIG. 4B shows the selective barrier layer 56′ and the desorbing media region 50′ of FIG. 4A in the expanded, desorptive configuration. In the expanded, desorptive configuration, the sorbent article 20 comprises the overall thickness T2′. The sorbent region 28 comprises a second thickness T4′ measured from the selective barrier layer 56′ to the upper boundary of the sorbent article 20. In this desorptive configuration, the desorption channels 52a-f′ are shown in an expanded state with each of the desorption channels 52a-f′ having a cross-sectional profile that is generally circular. Each of the desorption channels 52a-f′ have a width D2′ (i.e., diameter) that exceeds the collapsed width D1′ of FIG. 4A and may be approximately 0.5 mm to 2 mm. The desorption channels 52a-f′ function such that a desorbing media 66 (FIG. 2) is directed through the channels 52a-f′ during the desorption process.

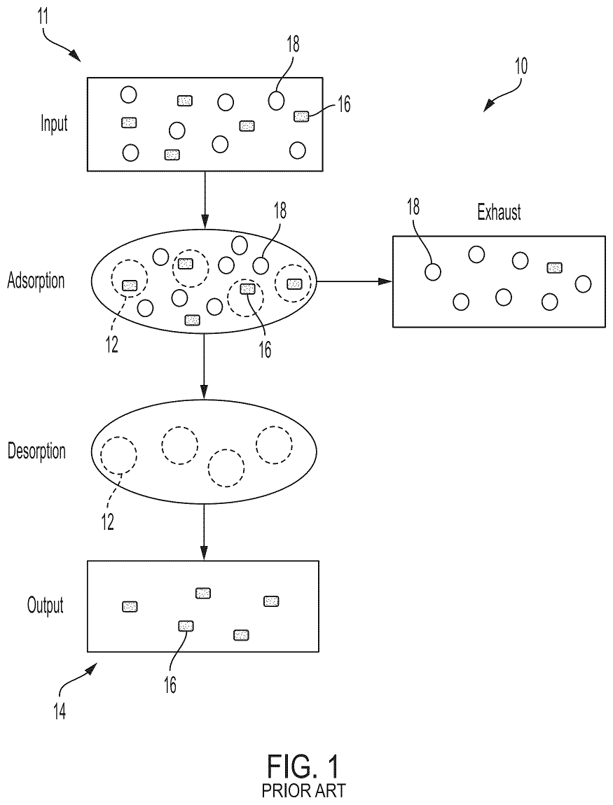

As described with reference to FIGS. 3A and 3B, the first porous polymer 22 (FIG. 3A) of the sorbent region 28 may be flexible. As such, the sorbent region 28 may be flexible in at least one direction, such that it is able to compress and expand. The sorbent region 28 illustrated in FIG. 4B is shown generally compressed compared to in the adsorptive configuration of FIG. 4A, such that the second thickness T4′ is less than the first thickness T3′. In these embodiments, the sorbent article 20 may retain a substantially constant overall thickness T1′ when transitioning from the adsorptive configuration to the desorptive configuration while the sorbent region 28 compresses. This compression may be due to the expansion of the desorbing media region 50′ when the desorbing media 66 (FIG. 1) is directed through the desorbing media region 50′. This compression may also cause the sorbent region 28 to have an increased density while the sorbent article 20 is in the desorptive configuration. The compression of the sorbent region 28 to the second thickness T4′ may be beneficial for various reasons during the desorption of FIG. 4B, such as for, but not limited to, an increased ability for heat retention within the sorbent region 28 and an ability for the sorbent article 20 to be retained within a fixed-volume housing. When the desorbing media region 50′ is compressed back into the adsorptive configuration of FIG. 4A, the reduction of the pressure on sorbent region 28 may allow for the sorbent region 28 to expand back to the first thickness T3′. In other embodiments, the sorbent region 28 may be rigid, such that the thickness T4′ of the sorbent region 28 in the desorptive configuration is substantially the same as the thickness T3′ in the adsorptive configuration. In this way, changing the width of the desorbing media region 50′ changes the thickness T1′ of the sorbent article 20 by substantially the same amount.

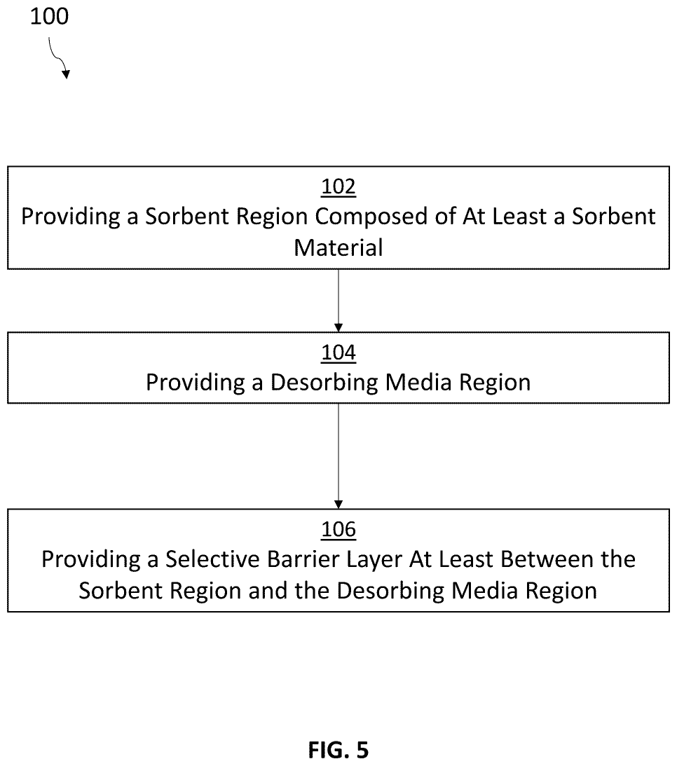

FIG. 5 is an illustrative embodiment of a method 100 for forming the sorbent article 20 of FIGS. 3A and 3B. The method 100 may be adjusted to form the sorbent article 20 having the desorbing media region 50′ of FIGS. 4A and 4B, but it is not limited to the formation of the embodiments of FIGS. 3A and 3B or of FIGS. 4A and 4B.

At block 102, the method 100 first comprises the step of providing at least one sorbent region 28. In various embodiments, this step further comprises providing a sorbent region 28 and an outer porous polymer region 36 configured for attachment to the sorbent region 28.

At block 104, the method 100 further comprises the step of providing a desorbing media region 50.

At block 106, the method 100 further includes providing a selective barrier layer 56 at least between the sorbent region 28 and the desorbing media region 50. In various embodiments, this step further comprises surrounding the desorbing media region 50 with the selective barrier layer 56 such that the selective barrier layer 56 comprises a first wall 51, a second wall 53 and at least one flexible internal wall 54. In other embodiments, this step may comprise surrounding the sorbent region 28 with the selective barrier layer 56. The providing of the selective barrier layer 56 may further comprise attaching the sorbent region 28 to the first wall 51 of the selective barrier layer 56. In certain instances, the providing step includes laminating the sorbent region 28 to the first wall 51 of the selective barrier layer 56. In embodiments, there is a second sorbent region 28′. In these embodiments, the method 100 further comprises the step of attaching the additional sorbent region 28′ to the second wall 53 of the selective barrier layer 56 surrounding the desorbing media region 50. In certain instances, this attaching step includes laminating the additional sorbent region 28′ to the second wall 53. In other embodiments, the attaching steps may include coupling or adhering the additional sorbent region 28′ to the second wall 53 of the selective barrier layer 56.

FIG. 6 is an elevational view of a module 60 of the present disclosure, the module 60 including two sorbent articles 20. In other embodiments, the module 60 may include a greater number of sorbent articles 20. The sorbent articles 20 of FIG. 6 each comprise the desorption channels 52a-f′ as illustrated in the selective barrier layer 56′ of FIG. 4B. The desorption channels 52a-f′ are shown in the expanded, desorptive configuration of FIG. 4B and have a generally circular cross-sectional profile. The desorptive configuration is configured for a maximized flow of desorbing media 66 through the expanded desorption channels 52a-f′. In certain embodiments, this desorbing media 66 is steam. The desorbing media 66 is directed through the desorption channels 52a-f′ along a generally vertical axis 64. In this way, the desorbing media 66 only contacts the walls 54′ of the selective barrier layer 56′ and does not directly contact the sorbent region 28 (FIG. 3A). Additionally, the application of the desorbing media 66 along the vertical axis 64 allows for the excess desorbing media 66 (e.g., condensed water from the steam) to leave the module 60 by the force of gravity. Further, a feed stream 68 can be applied to the module 60 along a generally horizontal axis 62 and in between the individual sorbent articles 20. In certain embodiments, the feed stream 68 is an air flow. In instances, the air flow comprises carbon dioxide. The spacings between the sorbent articles 20 through which this feed stream 58 is directed constitute adsorption pathways 78 of the module 60.

In some examples, cooling liquid (coolant) may also be received in the desorbing media region 50 to actively cool the sorbent article 20 to a temperature that discourages oxidation. For example, in the sorbent article 20 with the channels 52a-f passing therethrough, such coolant may be passed through the sorbent article 20 via the channels 52a-f. In some examples, the sorbent article 20 may be subjected to the feed stream 68 at the sorbent region 28, after which the desorbing media 66, such as the heat from a steam, etc., may be applied, to facilitate desorption of CO₂. After the desorption is completed, the sorbent article 20 may be cooled, for example by passing a refrigerant or cold water through the desorbing media region 50, after which the adsorption process may be initiated again to begin the next adsorption/desorption cycle.

FIG. 7A is a top view a module 60′ of the present disclosure in the adsorptive configuration during adsorption. The module 60′ is composed of a plurality of sorbent articles 20 positioned adjacent one another and within an outer housing 80. While this embodiment illustrates six sorbent articles 20 positioned within the outer housing 80, the number and arrangement of sorbent articles 20 is variable. In some embodiments, the number of sorbent articles 20 is chosen based on size constraints of the outer housing 80 of a desired embodiment.

The outer housing 80 may vary in size and shape. In embodiments, the outer housing 80 is a generally square container with at least four walls and at least one open side in order for the sorbent articles 20 to be placed inside. In other embodiments, the outer housing 80 may be a flat surface with at least two sides to maintain the positioning of the sorbent articles 20. Further, in other embodiments, the outer housing 80 may have any shape or construction that allows for the retention of the sorbent articles 20 and the introduction of the feed stream 68 during adsorption and the desorbing media 66 during desorption (FIG. 6).

The module 60′ comprises the adsorption pathways 78a-g that are formed on either side of each sorbent article 20, including the spaces between the adjacent sorbent articles 20. The desorption channels 52a-g of each of the plurality of sorbent articles 20 are shown in a collapsed configuration, whereas the adsorption pathways 78a-g are expanded. This adsorptive configuration may be caused by pressurizing the adsorption pathways 78a-g with the feed stream 68 (FIG. 6) and collapsing the substantially empty or unused desorption channels 52a-g. In this way, the adsorption pathways 78a-g have a greater size in the adsorptive configuration (FIG. 7A) than in the desorptive configuration (FIG. 7B) to accommodate the feed stream 68. In systems which utilize vacuum, or negative pressure to assist the desorption process, the negative pressure may also be used as a force to collapse the sorbent article 20.

FIG. 7B is a top view of the module 60′ of FIG. 7A in a desorptive configuration during desorption. In this configuration, the desorption channels 52a-g of each of the plurality of sorbent articles 20 are expanded. The expansion of the desorption channels 52a-g and the compression of the adsorption pathways 78a-g may be achieved by pressurizing the desorption channels 52a-g with the desorbing media 66 (FIG. 6) and collapsing the substantially empty or unused adsorption pathways 78a-g. In certain instances, the desorbing media 66 is steam. In these instances, the heat from the steam can permeate through the desorption channels 52a-g into the at least one sorbent region 28 (FIG. 3A) of each sorbent article 20. As mentioned previously, additional components, coatings and adhesive may be used to increase the thermal conductivity, especially at the interface of the desorbing media region 50 and the sorbent region 28. Further, as mentioned previously, additional variants of the desorbing media 66 may be used as opposed to steam.

While the modules 60, 60′ are described with the use of discrete sorbent articles 20 above, various other embodiments of the modules 60, 60′ are imagined within the scope of the present disclosure. For example, the sorbent article 20 may be formed as one sheet that is able to wrap in a coiled manner or a folded manner, such that the one sorbent article 20 forms multiple layers to form the modules 60, 60′. In this way, the one sorbent article 20 is used, but there are multiple layers of the desorbing media region 50 positioned adjacent one another.

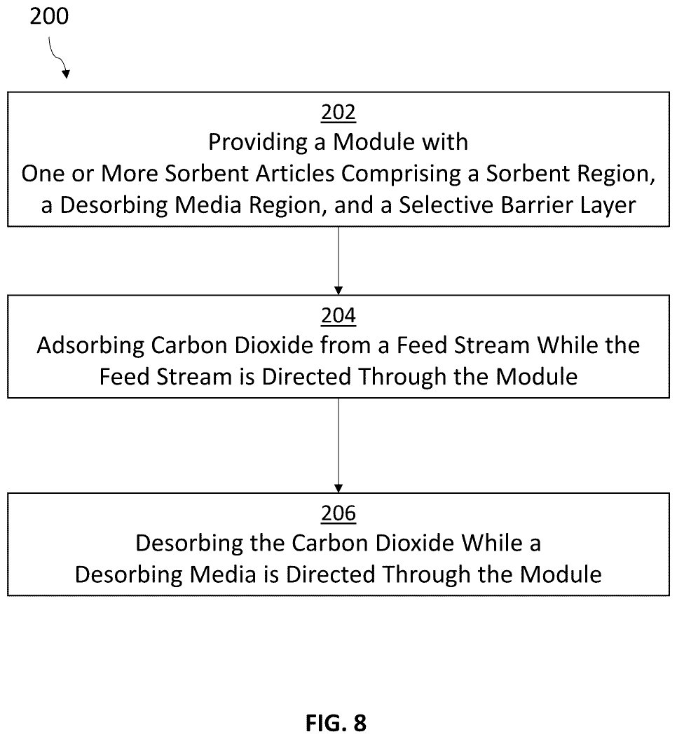

FIG. 8 is an illustrative embodiment of a method 200 of use of a module 60′ of the present disclosure, illustratively the module 60′ of FIGS. 7A and 7B. In embodiments, the method 200 may also be used for DAC with the module 60 of FIG. 6.

At block 202, the method first comprises providing a module 60′ composed of one or more sorbent articles 20 each comprising the sorbent region 28, a desorbing media region 50 and the selective barrier layer 56. When more than one sorbent article 20 is used, the sorbent articles 20 are positioned adjacent one another. The sorbent articles 20 are positioned within the outer housing 80 as explained above.

At block 204, the method 200 further comprises adsorbing carbon dioxide from the feed stream 68 (FIG. 6) while the feed stream 68 is directed into and through the module 60′. The application of the feed stream 68 includes directing the feed stream 68 into the adsorption pathways 78a-e of the module 60′. During application of the feed stream 68, the pressure may cause the desorption pathways 52a-g to collapse and the adsorption pathways 78a-e to expand, as shown in FIG. 7A. In this way, the amount of feed stream 68 that passes through the module 60′ may be maximized and the pressure required to force the feed stream 68 through will be minimized. In various embodiments, the module 60′ has a fixed volume. In these embodiments, during the adsorbing step, the sorbent region 28 occupies more of the fixed volume of the module 60′ than it does during the desorbing step (FIG. 7B). The carbon dioxide within the feed stream 68 is exposed to the at least one sorbent region 28 (FIG. 3A) of the sorbent article 20. The sorbent material 24, 24′ (FIG. 3A) within the at least one sorbent region 28 adsorbs the carbon dioxide until it approaches, or reaches, a maximum adsorbance capacity. In other embodiments, the sorbent material 24, 24′ (FIG. 3A) within the at least one sorbent region 28 adsorbs the carbon dioxide until an equilibrium is reached.

At block 206, the method 200 then includes desorbing the carbon dioxide while the desorbing media 66 is directed into and through the module 60′. During this step, the desorbing media 66 (FIG. 6) is directed through the desorption channels 52a-g. The application of the desorbing media 66 into the desorption channels 52a-g may allow for expansion of the desorption channels 52a-g and the collapsing of the adsorption pathways 78a-e. In various embodiments, pressure changes within the module 60′ may cause for the collapsing of the adsorption pathways 78a-e such that the system switches to a desorptive configuration. In some instances, the pressure change is due to the lack of feed stream 68 passing through the adsorption pathways 78a-e. In this way, the amount of desorbing media 66 that can be directed through the module 60′ is maximized. Further, in various embodiments wherein the module 60′ has a fixed volume, during the desorbing step, the desorbing media region 50 occupies more of the fixed volume of the module 60′ than it does during the adsorbing step (FIG. 7A). In certain instances, the desorbing media 66 is steam. The heat from the steam is able to permeate from desorbing media region 50 of the sorbent article 20, through the selective barrier layer 56, and into the sorbent region 28 (FIG. 3A) to desorb the carbon dioxide within the sorbent article 20. In this embodiment, the carbon dioxide is captured using temperature swing adsorption.

In embodiments, the method 200 further comprises collecting the carbon dioxide that is desorbed from each sorbent article 20. Once the desorption and collection of the carbon dioxide is complete, the method 200 may further comprise applying the feed stream 68 to the adsorption pathways 78a-e of the sorbent article 20 to return the module into an adsorptive configuration and repeating the adsorption process of block 204. The module 60′ is configured such that the sorbent article 20 may be subjected to repeated cycles of adsorption at block 204 and desorption at block 206, due to the ability of the selective barrier layer 56 to reversibly collapse and expand. As previously mentioned, the ability of the adsorption pathways 78a-e and the desorption channels 52a-f to collapse and expand during the various configurations allows the volume of the module 60′ to be maximized for adsorption or desorption during each respective configuration while maintaining the overall dimensions of the module 60′ based on the outer housing 80.

In the embodiments described above, the selective barrier layer 56 includes interior flexible walls 54 that allow the sorbent article 20 to collapse into an adsorptive configuration (FIG. 3A) and expand into a desorptive configuration (FIG. 3B). In other embodiments, the selective barrier layer 56 may be non-collapsible and retain its shape between adsorption and desorption. Even in these non-collapsible embodiments, the selective barrier layer 56 may be impermeable to water and water vapor to protect the sorbent material 24, 24′ of the sorbent region 28 from the desorbing media 66 passing through the various desorption channels 52a-f.

### Example A

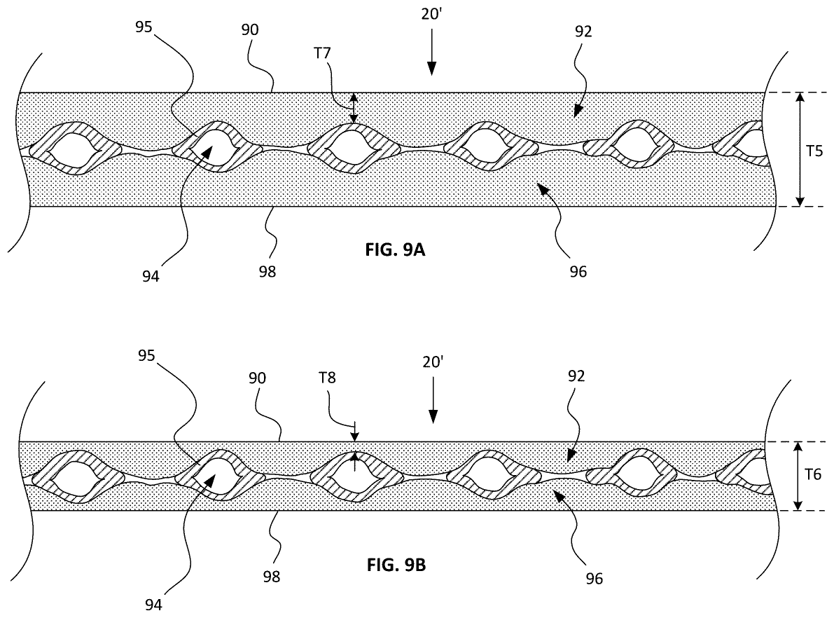

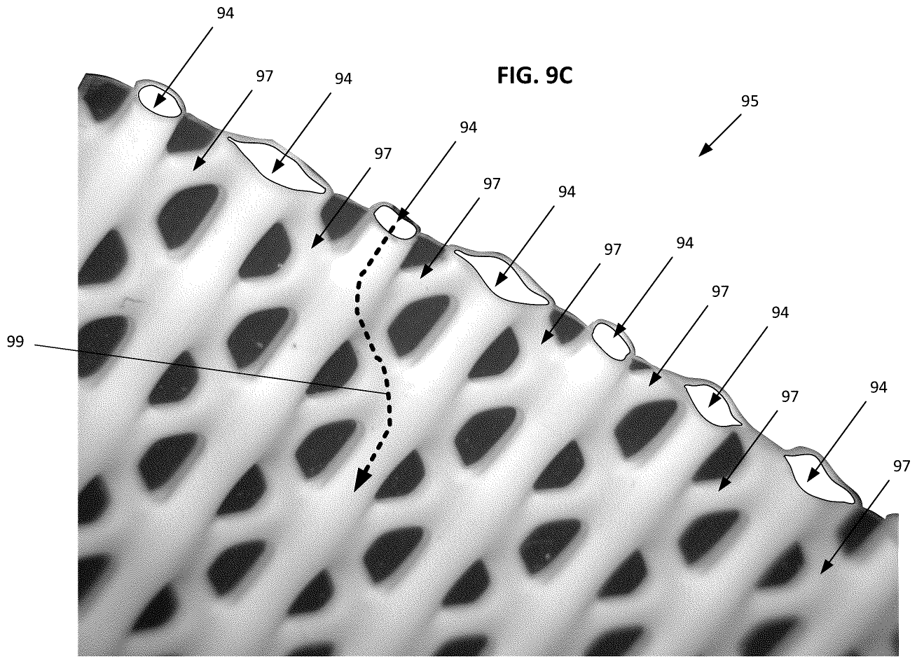

The following components will be described with reference to FIGS. 9A and 9B. FIG. 9A is a cross-sectional view of a sorbent article 20′ in a first configuration. For each of a first and second sorbent polymer composite (SPC) regions 92, 96, a sorbent article was produced incorporating a sorbent filled tape. The sample was produced by obtaining an amorphous silica powder (Syloid C 803, available from Grace Industries, Columbia, MD.) and combining with a PTFE resin. The proportions of the blend were 60% by weight of silica and 40% by weight of PTFE. The components were blended using the process described in U.S. Pat. No. 4,985,296 to Mortimer, Jr. The process included mixing the blend of 60% by weight silica and 40% by weight of PTFE in an aqueous dispersion. Next, the process included coagulating the filler and the PTFE. The process then included lubricating the filled PTFE with an extrusion lubricant (Isopar K) and paste extruding to form a tape. The process then included expanding the tape by stretching it and forming the porous PTFE tape with the filler distributed within it, and lastly partially densifying the material by compressing it to the desired thickness. The resultant filled tape measured approximately 0.762 mm thick and 150 mm wide. This tape was cut into samples approximately 53 mm×85 mm.

For the interior channel component, an ePTFE multi-conductor was fabricated according to the teachings in U.S. Pat. No. 3,082,292 to Gore.

For each of a first and second exterior layers 90, 98 an expanded ePTFE membrane was obtained which was produced in accordance with the teachings of U.S. Pat. No. 5,814,405 to Branca et al.

The ePTFE membrane was placed on both surfaces of the sample.

An assembled stack of components was compiled in the following order: (1) First External Region/Layer 90, (2) SPC Region 92, (3) Interior Channel 94 surrounded by Selective Barrier Layer 95, (4) SPC Region 96 and (5) Second External Region/Layer 98. This 5-region stack of components was then placed in a Carver hydraulic press and compressed between shims of aluminum. The pressure compressed the sample to approximately ⅓ its original thickness. The samples were removed from the press, the conductors were removed from the interior of the Interior Channel Component and the sample was trimmed to approximately 53 mm×85 mm. The resultant sample had several 0.5 mm channels within regions of the sorbent polymer composite and had a breathable, yet waterproof layer of ePTFE on both surfaces.

FIG. 9A shows the first exterior layer 90 having a thickness T7, and the sorbent article 20′ having an overall thickness T5. FIG. 9B is a cross-sectional view of the sorbent article 20′ in a second configuration. As shown generally in FIG. 9B, the first exterior layer 90 has a thickness T8 that is different from T7 and/or the sorbent article 20′ has an overall thickness T6 that is different from T5. In some examples, the thicknesses T6 and/or T8 in the second configuration may be less than the thicknesses T5 and/or T7, respectively, when the second configuration is a compressed configuration as compared to the first configuration, which may be an uncompressed or less compressed configuration. The compression may be caused manually, such as by pressing something against an external surface of the sorbent article 20′, or passively, such as due to a change in pressure of the environment surrounding the sorbent article 20′. In some examples, the thicknesses T6 and/or T8 in the second configuration may be greater than the thicknesses T5 and/or T7, respectively, when the second configuration is an expanded configuration as compared to the first configuration.

It is to be noted that, while the thicknesses T5, T6, T7, and/or T8 may change when transitioning from one configuration to another, the size and/or shape of the interior channel 94 and/or the selective barrier layer 95 may remain the same. That is, the material forming the selective barrier layer 95 may be sufficiently firm, semi-compliant, or non-compliant such that the pressure applied to the exterior layers 90, 98 to change the thicknesses from T5 and T6 to T7 and T8, respectively, does not affect the size of the interior channel 94 and/or the selective barrier layer 95. For example, the cross-sectional size of the interior channel 94 and/or the selective barrier layer 95, including but not limited to shape or diameter, may remain relatively unaffected by such thickness changes.

As shown in FIG. 9C, the selective barrier layer 95 may be defined by a single support layer component with interconnected channels 97. That is, each interior channel 94 is interconnected with at least one, or in some cases all, of the other interior channels 94 via one or more interconnected channels 97 which are incorporated in the support layer component. Therefore, the interior channels 94 may be either independent of one another (that is, not connected with another, adjacent interior channel 94) or interconnected via the interconnected channels 97 as shown by an exemplary fluid flow 99 from one interior channel 94 to another, adjacent interior channel 94.

### Example B

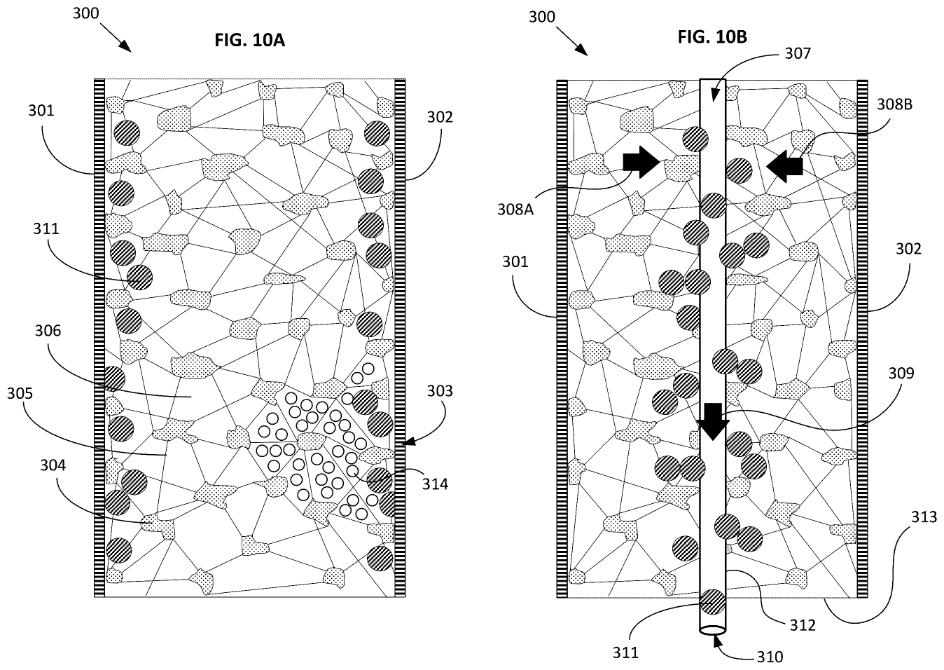

The following components will be described with reference to FIGS. 10A and 10B. FIG. 10A is a cross-sectional view of a sorbent article 300, and FIG. 10B is a cross-sectional view of a sorbent article 300 with a channel 307. The cross-sectional views of FIGS. 10A and 10B may represent a variety of orientations, or viewing angles for the sorbent article 300. That is, according to some embodiments, the cross-sectional view of FIGS. 9A and 9B may be a top, or plan view of the sorbent article (e.g., along the y-axis) whereas the cross-sectional view of FIGS. 10A and 10B may be a side view of the same sorbent article (e.g., along the x- or z-axis).

In the process of capturing CO₂, the sorbent article 300 may receive water internally within the sorbent article 300 in the form of steam. Evaporation of water vapor from the steam may lower the internal temperature of the sorbent article 300 and facilitate the CO₂ capturing process. However, not all of the water vapor may completely evaporate, so a portion of the water vapor may remain inside the sorbent article 300 (e.g., as water droplets or condensation). In some scenarios, a presence of condensation within the sorbent article 300 may reduce the efficiency of CO₂ capturing capability of the sorbent article 300—i.e., the presence of increased moisture within the sorbent article 300 may reduce CO₂ capturing capability. As such, it may be preferable to remove as much of the condensation or other moisture from the sorbent article 300 as possible to keep the sorbent article 300 relatively dry. In this regard, the channel 307 may be configured to facilitate water (for example, water droplets or condensation) that is collected inside the sorbent article 300 to be drained from the sorbent article 300, as further explained.

The sorbent article 300 has one or more layers 301 and/or 302 disposed or positioned on either or both sides of the sorbent article 300. In some embodiments, the layers 301, 302 may be selective barrier layers that are selectively permeable to water vapor but selectively impermeable to liquid water such that water vapor may pass through the barrier layers while liquid water (e.g., water droplets) are prevented from passing through the barrier layers. In some embodiments, the layers 301, 302 may be made of, or coated with, a hydrophobic material such as ePTFE, for example.

The sorbent article 300 in some examples may include a sorbent and hydrophilic material 303, where the material 303 may cause some of the water vapor (e.g., caused by steam) to form condensation within the structure of the sorbent article 300. The sorbent article 300 may comprise a porous microstructure of a plurality of nodes 304 and a plurality of fibrils 305 that connect adjacent nodes 304. The sorbent article 300 may be SPC, for example comprising ePTFE, ePE, and a suitable sorbent material. The sorbent article 300 may be treated or otherwise modified to be hydrophilic, for example via methods such as hydrophilic surface modification. In these instances, the nodes 304 and fibrils 305 form pores 306 bordered by the nodes 304 and fibrils 305.

Also shown in FIG. 10A are a portion of hydrophilic elements 314 of the sorbent article 300 according to some examples. It is to be understood that the hydrophilic elements 314 may be distributed evenly or unevenly throughout the sorbent article 300. For example, the hydrophilic elements 314 may be separate components or particles with hydrophilicity which may be caused by a coating of the hydrophilic material 303 being applied to the surface of the elements 314 or the elements being imbued or imbibed with such hydrophilic material 303. For example, the hydrophilic material 303 may be polyethyleneimine (PEI), salts, or ionic exchange resins, among others. In some examples, the hydrophilic elements 314 may be present as a filling or entrained particles. In some examples, the sorbent article 300 is coated with the hydrophilic material 303, such that the hydrophilic material 303 forms a substantially continuous coating on the nodes 304 and/or fibrils 305 of the sorbent article 300. It is also within the scope of the present disclosure for the sorbent article 300 to be filled with the hydrophilic elements 314 such that the hydrophilic elements 314 are incorporated into the nodes 304 and/or fibrils 305 of the sorbent article 300. In some examples, the particles of the hydrophilic elements 314 are entrained in the sorbent article 300, such that the hydrophilic elements 314 occupy the pores 306 between the nodes 304 and fibrils 305 of the sorbent article 300.

In some examples, the hydrophilic elements 314 may be a plurality of carriers of the hydrophilic coating made of the hydrophilic material 303. A carrier may be configured to increase the surface area of the region (e.g., the pores 306) it occupies which may allow for an increased surface area that is available for adsorption of the desired substance. The carrier may include a mesoporous silica, polystyrene beads, porous polymeric bed or sphere, oxide supports, or any other suitable carrier material. The carrier may further include a porous film comprising porous inorganic materials within it such as calcium sulfate, alumina, activated charcoal and fumed silica. The carrier may be present in the pores 306 of the sorbent article 300 as high surface area particles that are coated or functionalized with the hydrophilic material 303. The combination of the carrier coated with the hydrophilic material 303 increases the surface area available for adsorption.

In some embodiments, the nodes 304 and fibrils 305 may be partially or completely coated with a sorbent material, for example the sorbent material (24, 24′) which in some examples may be the hydrophilic material 303. When the nodes 304 and fibrils 305 are not coated, the original hydrophobicity of the sorbent article 300 may be retained.

Outer layers 301 and 302 may prevent water droplets or condensation 311 from leaving the hydrophilic interior material 303 of the sorbent article 300, as shown in FIG. 10A. To facilitate water drainage, the channel 307 is placed internally within the sorbent article 300 such that the condensation 311 is directed to move inwardly or away from the outer layers 301 and 302 and toward the channel 307, as shown by the arrows 308A and 308B. In this case, as shown, the channel 307 is surrounded on two sides by the interior material 303, but it is to be understood that in some examples, only one side of the channel 307 may be in contact with the interior material 303, while the other side of the channel 307 may be covered by the outer layer 301 or 302, or alternatively exposed to the surrounding environment. In some examples, the movement shown by the arrows 308A and 308B of the condensation 311 may be facilitated by applying inward pressure to the outer layers 301, 302 or by blowing air or gas into the sorbent article 300 from both sides thereof, for example. In some examples, hydrophobicity (i.e., hydrophobic forces) facilitates movement of water within the sorbent article. Any other suitable active or passive methods may be implemented to facilitate such movement.

A wall (or walls) 312 of the channel 307 may be made of a material that is porous and water permeable, which facilitates passage of the condensation 311 through the wall 312 and collection of the condensation 311 inside the channel 307. Gravity may cause the condensation 311 within the channel 307 to translate within the sorbent article 300 (e.g., fall downward), as shown by the arrow 309, after which the condensation 311 may leave the sorbent article 300 via a drainage opening 310 formed at or proximate an end of the channel 307 or at another location along the channel 307. In some examples, the drainage opening 310 is located at the bottom of the sorbent article 300, and in some examples, the wall 312 protrudes past an end portion 313 of the sorbent article 300, causing a portion of the channel 307 to extend past the end portion 313 such that the drainage opening 310 is located external to the sorbent article 300.

In some embodiments, the channel 307 assumes a substantially straight and tubular configuration as appropriately defined by the size and shape of the wall (or walls) 312. In some embodiments, the channel 307 assumes a substantially curved or bent configuration. In some embodiments, the channel 307 assumes a spiral configuration. And, in some embodiments, the channel 307 has a consistent cross-sectional shape (e.g., circular, ovular, polygonal, etc.) or area along its entire length. In some embodiments, the channel 307 has varying cross-sectional shape or area along its length, for example having certain portions that are wider than other portions. For example, the channel 307 may assume a frustoconical configuration.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A sorbent article comprising:
a sorbent region comprising a sorbent material configured to adsorb and desorb a substance;
a desorbing media region positioned adjacent to the sorbent region configured to receive a desorbing media that desorbs the substance from the sorbent material; and
a selective barrier layer positioned at least between the sorbent region and the desorbing media region.

2. The sorbent article of claim 1, wherein the sorbent article is flexible in at least one direction.

3. The sorbent article of claim 1, wherein the sorbent article has a total thickness of approximately 0.5 mm to 1.0 cm.

4. The sorbent article of claim 1, wherein the sorbent region is a sorbent polymer composite region comprised of at least a porous polymer and the sorbent material.

5. The sorbent article of claim 1, wherein the selective barrier layer comprises a polymer.

6. The sorbent article of claim 5, wherein the polymer is polytetrafluoroethylene (PTFE).

7. The sorbent article of claim 1, further comprising a second sorbent region, wherein the sorbent region and the second sorbent region are positioned on opposing sides of the selective barrier layer.

8. The sorbent article of claim 7, wherein the sorbent region and the second sorbent region are identical.

9. The sorbent article of claim 1, wherein the selective barrier layer comprises at least one channel.

10. The sorbent article of claim 9, wherein the at least one channel is defined by at least a first, second and third wall of the selective barrier layer.

11. The sorbent article of claim 9, wherein the at least one channel may be compressed or expanded.

12. The sorbent article of claim 9, wherein the at least one channel of the sorbent article has a cross-sectional profile that is generally rectangular.

13. The sorbent article of claim 9, wherein the at least one channel of the selective barrier layer has a cross-sectional profile that is generally circular while expanded, and generally ovular when collapsed.

14. The sorbent article of claim 9, wherein each of the at least one channel has a height of approximately 0.5 mm to 2 mm when expanded.

15. The sorbent article of claim 9, wherein the at least one channel is defined by at least one channel wall comprising a porous and water-permeable material.

16. The sorbent article of claim 9, wherein the at least one channel comprises a drainage opening located proximate an end portion of the channel through which the water is configured to be drained from within the sorbent article.

17. The sorbent article of claim 1, wherein the selective barrier layer comprises at least two channels.

18. The sorbent article of claim 17, wherein the at least two channels are interconnected.

19. The sorbent article of claim 17, wherein the at least two channels are positioned generally parallel to one another.

20. The sorbent article of claim 1, wherein the selective barrier layer is non-collapsible such that the selective barrier layer retains its shape between an adsorption configuration and a desorption configuration.

21. The sorbent article of claim 1, wherein the selective barrier layer is selectively impermeable to water and water vapor.

22. The sorbent article of claim 1, wherein the selective barrier layer is selectively permeable to water vapor and selectively impermeable to water.

23.-53. (canceled)
